(19) United States
(12) Patent Application Publication
(10) Pub. No.: US 2004/0216040 A1
(43) Pub. Date: Oct. 28, 2004

(54) Product information contrast system

(75) Inventors: Mariko Aduma, Shizuoka (JP); Tetsuo Noji, Shizuoka (JP); Tetsuo Isoda, Shizuoka (JP); Seiji Ozawa, Shizuoka (JP); Manabu Satoh, Shizuoka (JP); Yoshihiro Sugiyama, Shizuoka (JP); Motonori Hanada, Shizuoka (JP)

Correspondence Address: MORRISON & FOERSTER LLP, 1650 TYSONS BOULEVARD, SUITE 300, MCLEAN, VA, 22102, US

(73) Assignee: RICOH COMPANY, LTD., Tokyo (JP)

(21) Appl. No.: 10/790,249

(22) Filed: Mar. 2, 2004

(30) Foreign Application Priority Data
Mar. 5, 2003 (JP) 2003-058916
Feb. 4, 2004 (JP) 2004-027900

(51) Int. Cl. G06F 17/21

(52) U.S. Cl. 715/511

(57) ABSTRACT

A product information contrast system contrasts a plurality of items of product information that contain specifications indicating properties of products. The product information contrast system comprises a product information management unit which manages the plurality of items of product information of the products including a criterion product. A judgment unit determines whether specifications in the product information items of the criterion product are different from specifications in the product information items of at least one of the products managed by the product information management unit. A display control unit generates a visually recognizable display indication of differences in the specifications of the product information items based on results of the determination of the judgment unit.

### BACKGROUND OF THE INVENTION

1. Field of the Invention

The present invention generally relates to a product information contrast system, and more specifically to a product information contrast system which manages a plurality of items of product information of products, such as consumable parts used for an electrophotographic printer etc., and contrasts the items of the product information of the products.

The product information hereinafter covers not only the information about the products themselves but also the extensive information about the manufacture of the products, including the conditions of the manufacturing devices of the products, the items of inspection information on the manufacture of the products, the facility specifications of the manufacturing devices, etc.

2. Description of the Related Art

Conventionally, the component parts and consumable parts of the products are also diversified with the diversification of the products, such as electrophotographic printers. In many cases, the respective component parts and consumable parts of the products are designed separately. That is, in order to complete the manufacture of a product, the usual course of manufacture is that various manufacturing sections of the manufacturer and the parts suppliers carry out the manufacture of the product in cooperation with each other.

Moreover, the product information regading the products is managed based on the predetermined specifications per product.

A description will now be given of a conventional procedure of development of the product using the product information thereof.

FIG. 1 is a block diagram for explaining a conventional procedure of development of the product.

As shown in FIG. 1, the product under development and the request properties of the manufacturing processes are first inputted and transferred to the system for development which develops the product using the product information (step S1), and the prescription design of the product is performed (step S2).

Next, the production preparations of the product is perfrmed (step S3), and after the production preparation is performed, the trial production and evaluation of the product are performed (step S4).

Next, design change is performed when a problem arises for the prototype product which is produced through the trial production (step S5).

The trial production and evaluation of the product to which the design change is effected is performed (step S6).

Moreover, when a problem of the design-changed product which is produced through the trial production arises, additional steps that are essentially the same as the steps S5 and S6 are repeated (steps S7 and S8).

In addition, the procedure of the development of the actual product is not limited to the procedure shown in FIG. 1, and the additional steps which are the same as the steps S5 and S6 are repeated until the problem of the product is eliminated.

Next, when the problem of the product is eliminated, the mass production of the development product is carried out (step S9), and the mass-produced product is sold and used in the market (step S10).

In the mass production of the step S9, when variations of the products are considerably large, degradation of the products, or the quality problem, arises (step S11).

For example, when considering the toner as one of the consumable parts, the typical materials used for the toner contain the resin, the CCA, the additive, the mold release agent, the pigment, and the MB (masterbatch). The material properties of the toner include the chemistry property, the carrier property, the optical property, the fine-particle property, the magnetic property, the ingredients, the particle-size distribution, the electrical property, the thermal property, the physical property, the appearance, other manufacture conditions, etc.

Thus, the toner is developed and manufactured in accordance with the specifications related to the raw material, the specifications related to the quality, the specifications related to the manufacture, etc. The current situation is that, even if the same raw materials are used, separate specifications are set independently by the differences of the manufacture conditions.

Specifications will change with respective products, and the setting of the specifications will also change with respective persons in charge who set the specifications.

If a quality problem, such as toner scattering, occurs as a result of the mass production of the product developed as shown in FIG. 1, the causes of the quality problem may be the out-of-range setting of the specifications by the person in charge at the design/development stage, the lack of setting of the level or the range in the specifications, the omission of the necessary evaluation, etc.

The countermeasures taken against the quality problem are to add new items of product information to the product specifications or the raw-material specifications, or update the product information so that certain restrictions may be included in the manufacture conditions or the changed level may be included in the inspection specifications.

Moreover, Japanese Laid-Open Patent Application No. 2002-157548 discloses a conventional system which provides display indications of two specification documents the contents of which are extremely similar so that such differences can be confirmed.

However, there is no disclosure or teaching in Japanese Laid-Open Patent Application No. 2002-157548 of comparing the two similar specification documents. The product information of the conventional system has the problem that such product information is inadequate for acquiring the differences between the product specifications of various products or the changes of the product information when the specifications differ for every product.

Moreover, when the setting of the product specifications after the mass production of a certain product has been changed and the development of a product similar to that product is conducted, it is impossible for the conventional system to judge whether the change portion is reflected in the product specifications of that product at the development stage. For this reason, it is difficult to prevent the occurrence of the quality problem.

Moreover, it is necessary for the conventional system to repeat change of the specifications of each product and the trial production of the product, and evaluation and to perform them until the problem of the product is eliminated as shown in FIG. 1, and it is difficult to reduce the the efficiency of development of the products.

### SUMMARY OF THE INVENTION

An object of the present invention is to provide an improved product information contrast system in which the above-described problems are eliminated.

Another object of the present invention is to provide a product information contrast system which raises the efficiency of the development of products and prevents the occurrence of a quality problem by comparing a plurality of items of product information and making the comparison results reflect in the product specifications of the product under development.

The above-mentioned objects of the present invention are achieved by a product information contrast system which contrasts a plurality of items of product information that contain specifications indicating properties of products, the product information contrast system comprising: a product information management unit managing the plurality of items of product information of the products including a criterion product; a judgment unit determining whether specifications in the product information items of the criterion product are different from specifications in the product information items of at least one of the products managed by the product information management unit; and a display control unit generating a visually recognizable display indication of differences in the specifications of the product information items based on results of the determination of the judgment unit.

According to the product information contrast system of the present invention, it is possible recognize visually the differences in the specifications between other products and the product under development which has the product information items used as the criteria of contrast. It is possible to make the differences reflected in the specifications of the product under development, and the efficiency of development of the product can be raised while preventing the occurrence of the quality problem.

### BRIEF DESCRIPTION OF THE DRAWINGS

Other objects, features and advantages of the present invention will be apparent from the following detailed description when reading in conjunction with the accompanying drawings.

FIG. 1 is a block diagram for explaining a conventional procedure of development of the product.

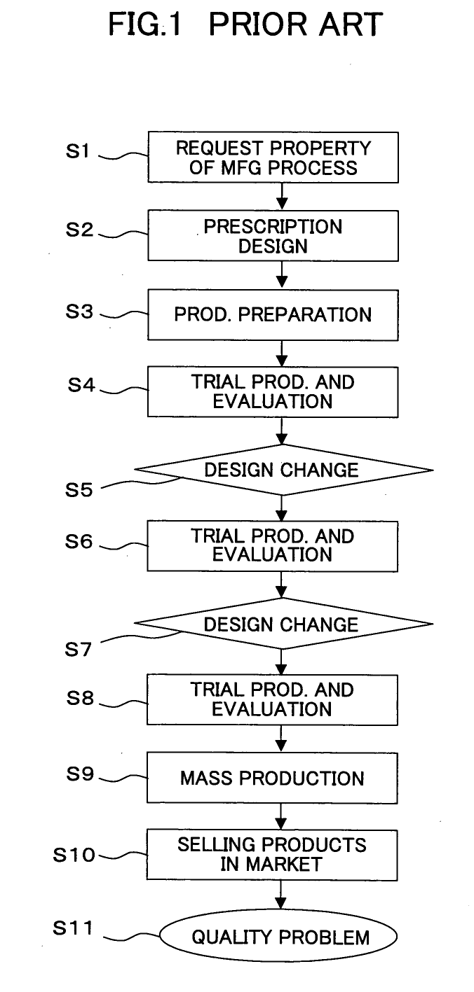

FIG. 2 is a block diagram of an embodiment of the product information contrast system of the invention.

FIG. 3 is a diagram for explaining a table stored in a product information database in the product information contrast system of the present embodiment.

FIG. 4 is a diagram for explaining another table stored in the product information database in the product information contrast system of the present embodiment.

FIG. 5A and FIG. 5B are diagrams for explaining a trasition of screens during the product information contrast processing.

FIG. 6 is a diagram for explaining a screen for contrasting the product information in the product information contrast processing.

FIG. 7 is a diagram for explaining a screen for contrasting the product information in the product information contrast processing.

FIG. 8 is a diagram for explaining a table stored in an alarm information database in the product information contrast system of the present embodiment.

FIG. 9 is a diagram for explaining a screen for indicating the alarm information in the product information contrast processing.

FIG. 10 is a diagram for explaining a screen for contrasting the raw material costs in the product information contrast processing.

FIG. 11 is a diagram for explaining the flow of a temporary master registration processing.

FIG. 12 is a diagram for explaining a screen for inputting data.

FIG. 13 is a diagram for explaining a screen for inputting a new term.

FIG. 14 is a diagram for explaining a screen of term registration request.

### DETAILED DESCRIPTION OF PREFERRED EMBODIMENTS

A description will now be given of the preferred embodiments of the invention with reference to the accompanying drawings.

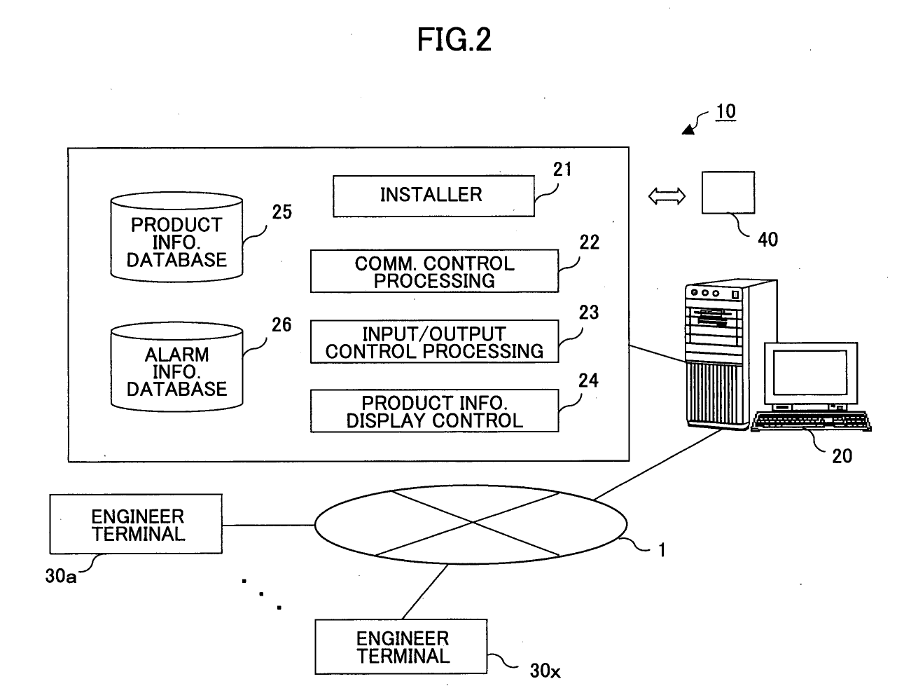

FIG. 2 is a block diagram of the preferred embodiment of the product information contrast system of the invention.

As shown in FIG. 2, the product information contrast system 10 in this embodiment comprises the product information-management server 20 which manages the product information of each of the developed products, and the development engineer terminals 30a-30x which are provided at the ends of the development engineers who develop the products based on the product information received from the server 20.

In addition, the product information management server 20 and the development engineer terminals 30a to 30x are connected together throught the network 1.

The product information management server 20 shown in FIG. 2 is a server computer provided with the following component units, and these component units are controlled by the CPU (central processing unit) of the server 20. The CPU carries out processing of the product information contrast system 10 in accordance with the program stored in the memory unit.

The product information management server 20 of FIG. 2 comprises the installer 21, the communication control processing unit 22, the input/output control processing unit 23, the product information display control unit 24, the product information database 25, and the alarm information database 26.

The installer 21 installs the program that causes the CPU to perform the product information management processing, into the memory of the product information-management server 20. The communication control processing unit 22 controls data communications between the server 20 and any of the terminals 30a to 30x via the network 1. The input/output control processing unit 23 controls the input/output processing of data in the server 20. The product information display control unit 24 controls display processing of the product information. In the product information database (called DB) 25, the product information is stored. In the alarm information DB 26, the alarm information for displaying the alarm is stored.

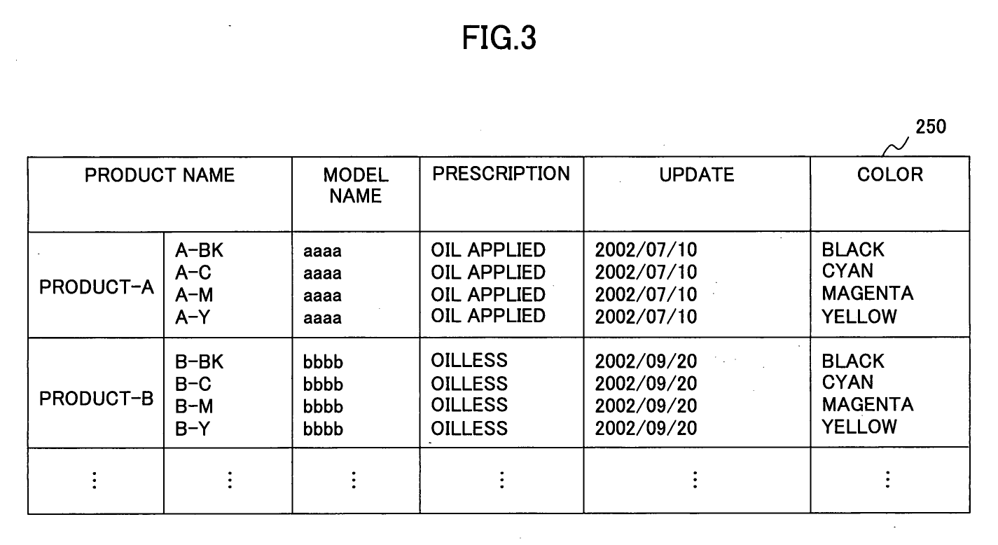

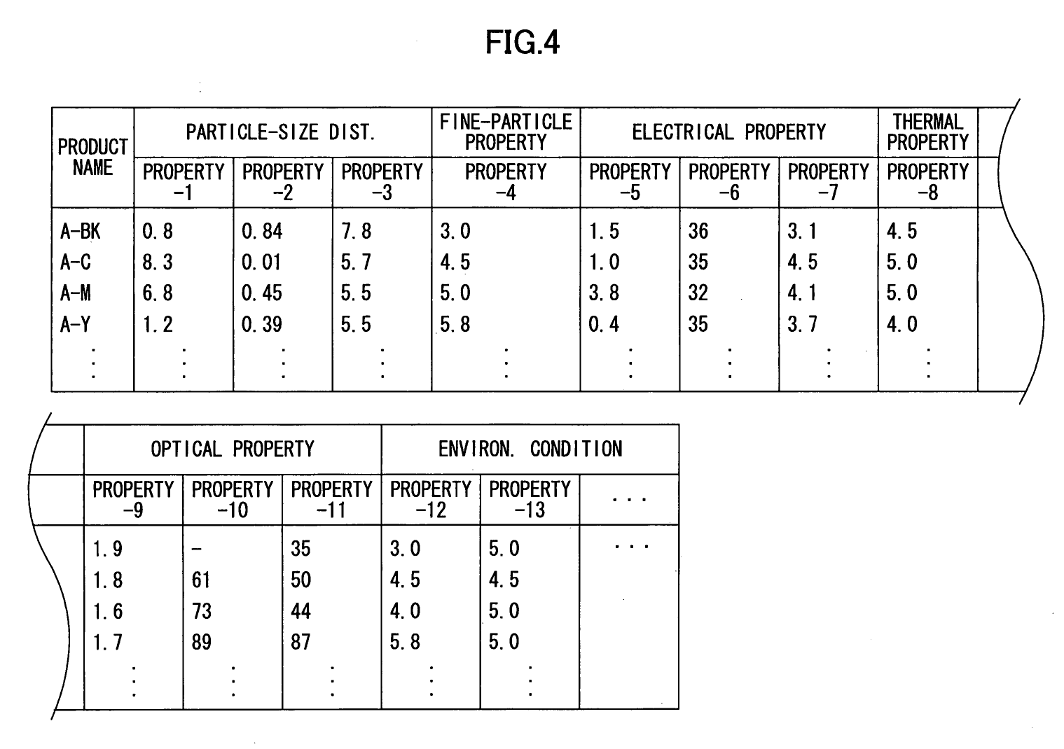

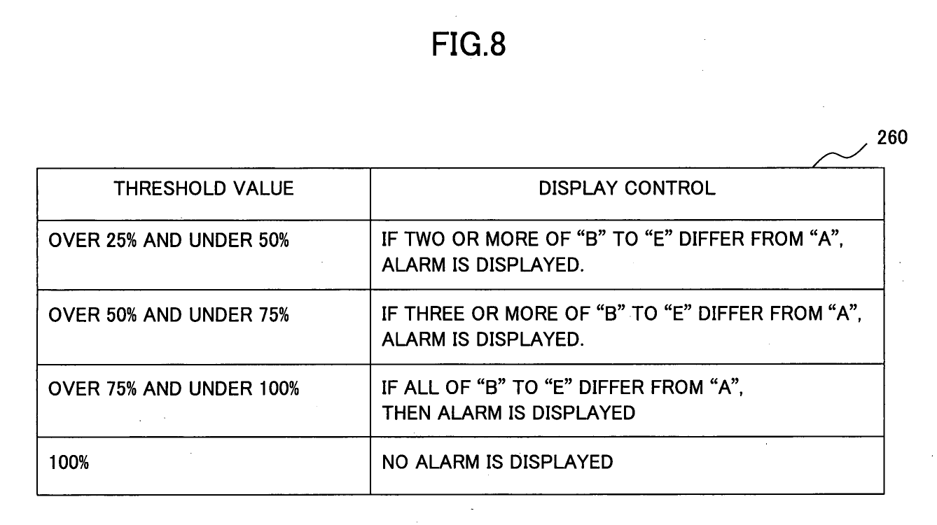

A detailed description of the table stored in the product information DB 25 will be given below with reference to FIG. 3 and FIG. 4. A detailed description of the table stored in the alarm information DB 26 will be given below with reference to FIG. 8.

The communication control processing unit 22 is the processing unit which controls transmission and reception of data by means of the network 1, and the communication control processing unit 22 is provided with the communication unit which connects the server 20 with the network 1 for the data communications.

The input/output control processing unit 23 controls the input units, such as a mouse and a keyboard, and the output units, such as a monitor (which is an analysis information output unit) and a printer, so that the input/output control processing unit 23 controls the input/output (I/O) of data.

The installer 21 reads the program from the recording medium 40 in which the program for realizing the processing of the product information contrast system of the present embodiment is recorded, and installs the read program into the auxiliary memory of the server 20. And when the product information contrast processing is started, the CPU starts performing the processing in accordance with the program recorded in the auxiliary memory.

In addition, the recording medium 40 may be any of computer-readable storage media, such as a ROM or a removable recording disk, in which the program is stored.

Moreover, the product information display control unit 24 is provided with a display monitor, such as a CRT display monitor, and generates a screen display indication of differences in a plurality of items of product information of plural products based on results of the comparison of the products by making reference to the product information stored in the product information DB 25 and the alarm information stored in the alarm information DB 26.

For example, when a command to start the product information contrast processing is inputted by the administrator (or the user) on the keyboard or mouse of the product information management server 20, the product information display control unit 24 starts performing the product information contrast processing.

The product information display control unit 24 displays the screen for contrasting the items of product information of the plurality of products specified by the administrator while displaying the screen for requesting the administrator to select any of the products. Especially, the screen for contrasting the items of product information includes the display region in which the newly set property values (which are not previously set) based on results of comparison of the criterion product and other products are indicated, and the display region in which the alarm displays of the new item, the omission, and the out-of-range setting of the product information based on a predetermined threshold are indicated. These display regions are displayed on the display monitor screen in a color different from the color of the background, such as blue or yellow.

Therefore, the administrator can easily recognize the different property values between the criterion product and other products, and the alarms of the new item, the omission, and the out-of-range setting of the product information by viewing the corresponding display regions of the different colors.

In addition, the development engineer terminals 30a-30x have the same composition as the above-mentioned product information management server 20, including the installer 21, the communication control processing unit 22, the input/output control processing unit 23, and the product information-display control unit 24, and a description thereof will be omitted.

Next, a description will be given of the tables stored in the product information DB.

FIG. 3 and FIG. 4 show examples of the tables stored in the product information DB 25.

The table 250 of FIG. 3, which is stored in the product information DB 25, includes the item which indicates the product name of the toner, the item which indicates the adapted model name, the item which indicates the prescription of the product, the item which indicates the date of update of the product information, and the item which indicates the color of the product.

As for the “Product-A”, the product name for every color of the toner is contained. For example, the items stored in the product name “A-BK” of the table 250 include the color “black”, the model name “aaaa”, the prescription “the oil appled”, and the date of update “2002 Jul. 10”.

The table 251 of FIG. 4, which is also stored in the product information DB 25, includes the item which indicates the product name of the toner, the item which indicates the property values 1-3 of the particle-size distribution, the item which indicates the property value 4 of the fine-particle property, the item which indicates the property values 5-7 of the electrical property, the item which indicates the property value 8 of the thermal property, the item which indicates the property values 9-11 of the optical property, and the item which indicates the property values 12-13 of the environmental condition, etc.

In addition, the items required for the contrast of other product information may be set up and modified, without being limited to the items included in the above-mentioned tables 250 and 251.

Next, a description will be given of a transition of the screens displayed on the display unit of the product information management server 20 during the product information contrast processing.

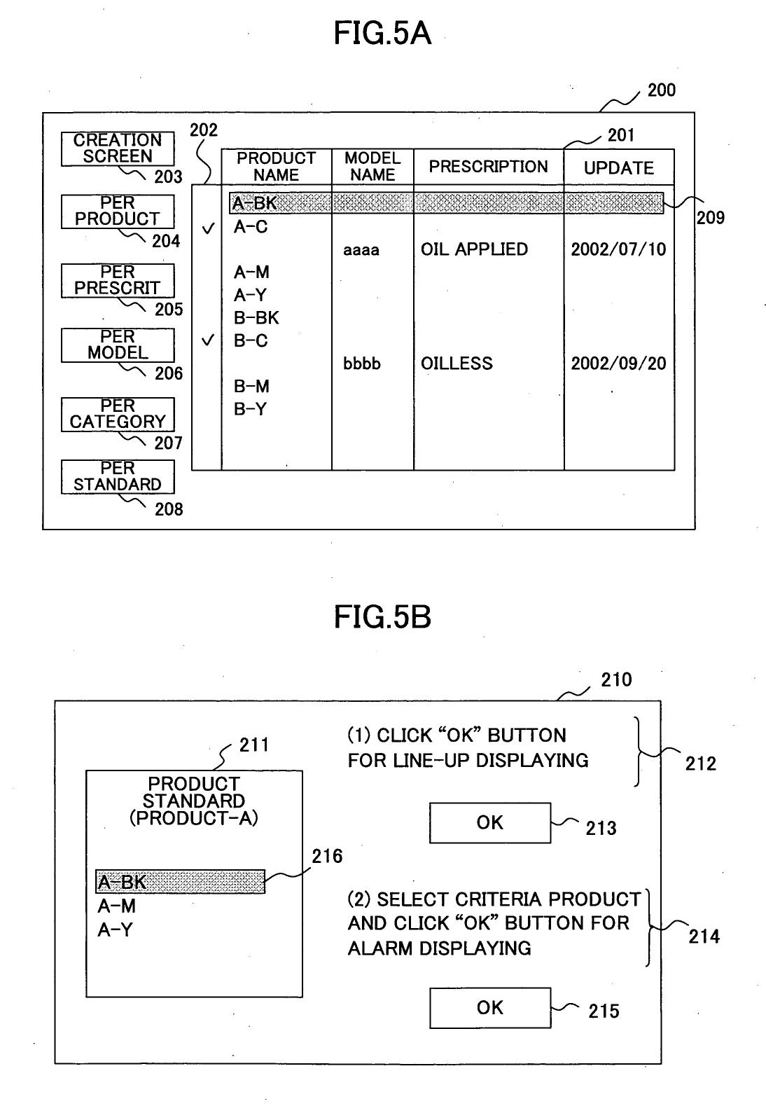

FIG. 5A and FIG. 5B are views for explaining a transition of the screens during the product information contrast processing.

FIG. 5A shows the screen 200 which is displayed upon starting of the product information contrast processing. FIG. 5B shows the screen 210 which is provided for the administrator (or the user) to choose the criterion product from among the plurality of products, the criterion product being used as the reference product at the time of contrasting the plurality of items of the product information of the products.

The screen 200 of FIG. 5A, which is displayed on the the display unit of the product information management server 20, includes the display region 201 where the product information is displayed, the input area 202 for choosing the product the detailed product information of which should be displayed, the creation screen button 203 with which the displaying of the creation screen of new product information is requested, the “per product” button 204 with which the displaying of the product information arranged according to the products is requested, the “per prescription” button 205 with which the displaying of the product information arranged according to the prescriptions is requested, the “per model” button 206 with which the displaying of the product information arranged according to the models is requested, the “per category” button 207 with which the displaying of the product information arragned according to the categories is requested, and the “per standard” button 208 with which the displaying of the product information according to the specifications is requested.

The product information stored in the table 250 of FIG. 3 is displayed in the display region 201 shown in FIG. 5A, and the items, which indicate the product name, the model name, the prescription, and the update date, for the respective products are displayed in the display region 201.

For example, if the administrator checks the input area 202 of the product name “A-C”, the detailed product information of the product name “A-C” is displayed in the display region 201.

Moreover, if the administrator clicks the “per product” button 204 in the state in which the product name “A-BK” is chosen as in the display region 209 shown in FIG. 5A, the screen 210 shown in FIG. 5B will be displayed.

The screen 210 of FIG. 5B, which is displayed on the the display unit as described above, includes the selection region 211 for choosing the criterion product the product specification of which shloud be displayed with the comparison with the of other products, the display region 212 which includes a message indicating that the differences in the prescription are identified and the items of the product information of the respective products arranged side by side are displayed if the O.K. button 213 is clicked, the O.K. button 213 with which the displaying of the product information arranged according to the presriptions is requested, the display region 214 which includes a message indicating that the criterion product is chosen and the alarm display indications of the new item, the omission or the out-of-range property of the product information are displayed if the O.K. button 215 is clicked, and the O.K. button 215 with which the criterion product is chosen and the displaying of the alarm display indications of the product information is requested.

In the selection region 211, the product names “A-BK”, “A-C”, “A-M”, and “A-Y”, which have the product specifications (product A), are displayed. For example, if the product name “A-BK” is chosen as the criterion product as shown in the display region 216 in the selection region 211, and the O.K. button 215 is clicked, the screen for contrasting the product information items of the selected criterion product and the other products, which will be described below, is displayed.

Next, a description will be given of the screen for contrasting the product information items of the selected criterion product and the other products.

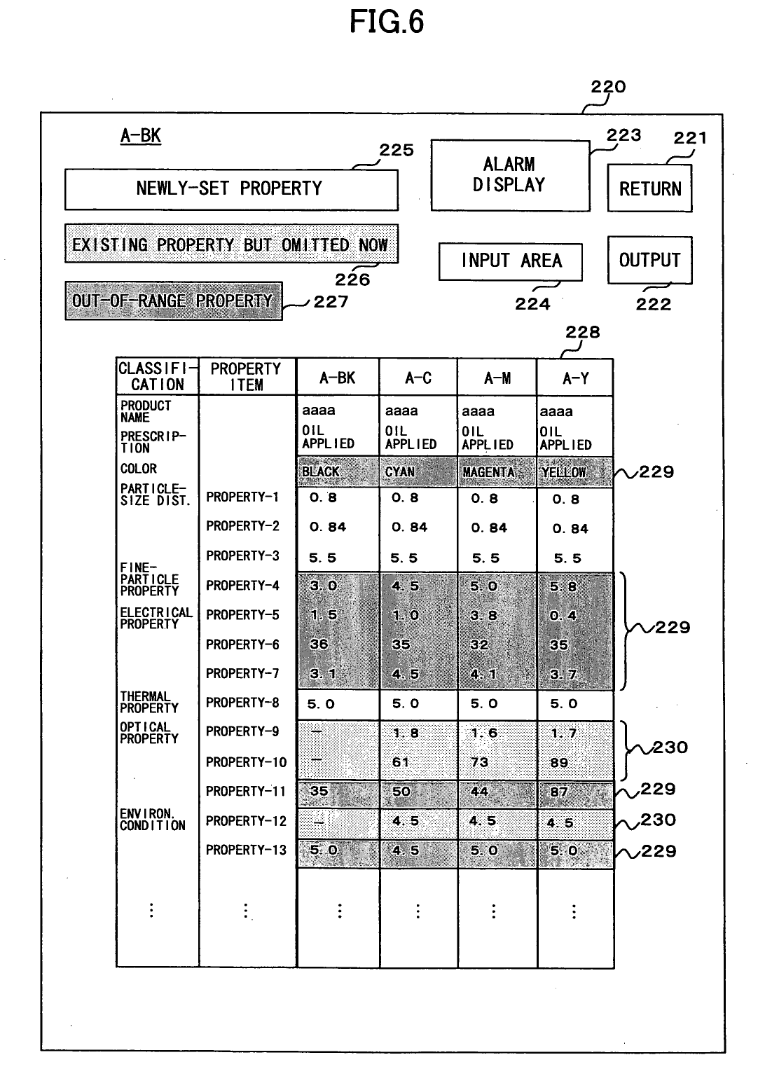

FIG. 6 is a diagram for explaining the screen for contrasting the product information in the product information contrast processing.

The screen 220 of FIG. 6 indicates the product information of the selected criterion product (herein, the product name “A-BK” chosen is displayed as the screen title) in contrast with the product information of the other products (belonging to the product A).

The screen 220 of FIG. 6 includes the button 221 for returning to the previously displayed screen, the output button 222 for outputting the information of the displayed screen 220 by using another processing unit, the button 223 with which the displaying of the alarm display indications of the new item, the omission, and the out-of-range property is requested, the input area 224 in which an input threshold value for the alarm display control is inputted, the display region 225 which indicates the color (the color and pattern) of the display region where the newly set property value which is not previously set is displayed, the display region 226 which indicates the color of the display region where the omitted property value which is not currently set is displayed, the display region 227 which indicates the color of the display region where the out-of-range property value is displayed, and the display region 228 which indicates the contrast results of the respective items of the product information between the criterion product and the other products.

In the display region 228, the classification column which indicates the classification of each product, the property column which indicates the property value related to each classification, and the product information columns which indicate the product information items of each of the product names “A-BK”, “A-C”, “A-M”, and “A-Y” are displayed.

In the classification column, the model name corresponding to the product, the prescription, the color, the particle-size distribution, the fine-particle property, the electrical property, the thermal property, the optical property, the environmental condition, etc. are displayed.

In the property column, the property values 1-13 corresponding to each of the respective properties of the product are displayed.

In addition, it is possible to make it display the property items required for contrast of other product information, without being limited to the property items shown in the display region 228. Moreover, the above-mentioned classification column and property column and their corresponding units are managed and stored in the product information DB 25 as the specifications.

In the display region 228, the contrast results of the product information items of the product name “A-BK” (which is the selected criterion product) and the product information items of the other product names “A-C”, “A-M”, and “A-Y” are displayed in the separate, distict colors as indicated in the display regions 229 and 230.

In the example of FIG. 6, when the specifications of the product information items of the criterion product “A-BK” are not included in the specifications of the product information items of the other products “A-C”, “A-M” and “A-Y” (or when they are the out-of-range property values), they are displayed as in the display regions 229 with the separate, distinct color that is the same as the color shown in the display region 227.

Moreover, in the example of FIG. 6, when any specifications other than the specifications of the product information items of the criterion product “A-BK” are included in the product information items of the other products “A-C”, “A-M” and “A-Y” (or when they are the omitted property values), they are displayed as in the display regions 230 with the separate, distinct color that is the same as the color shown in the display region 226.

In addition, in the example of FIG. 6, when some specifications of the product information items of the criterion product “A-BK” are newly set and not included in the specifications of the product information items of the other products “A-C”, “A-M” and “A-Y” (or when they are the newly set property values), there is no corresponding property value in the product information items of the criterion product “A-BK”, and they are not displayed with the separate, distinct color.

Accordingly, the product information items of the criterion product are compared with the product information items of the other products, and the property values which are different from those of the other products can be identified in the development process of the product by presenting the different-color alarm display indications according to the respective conditions.

For example, the administrator can recognize the differences in the property values between the criterion prouct and the other products by viewing the display regions 229 within the region 228. The administrator can easily check the meaning of the property value differences by notifying the same to the development enginner who sets up the specifications of the criterion product. Moreover, the administrator can recognize the omitted property values of the criterion prouct but existing in the specifications of the product information items of the other products by viewing the display regions 230 within the region 228. The administrator can easily check the meaning of the omitted property values of the criterion product by notifying the same to the development enginner who sets up the specifications of the criterion product.

Therefore, it is possible for the product information contrast system of the present embodiment to make the differences, obtained as the results of the recognition with the different-color alarm display indications, reflected in the specifications of the product under development, and while preventing the occurrence of the quality problem, the efficiency of development of the products can be raised.

Next, a description will be given of another example of the screen for contrasting the product information between the selected criterion product and the other products.

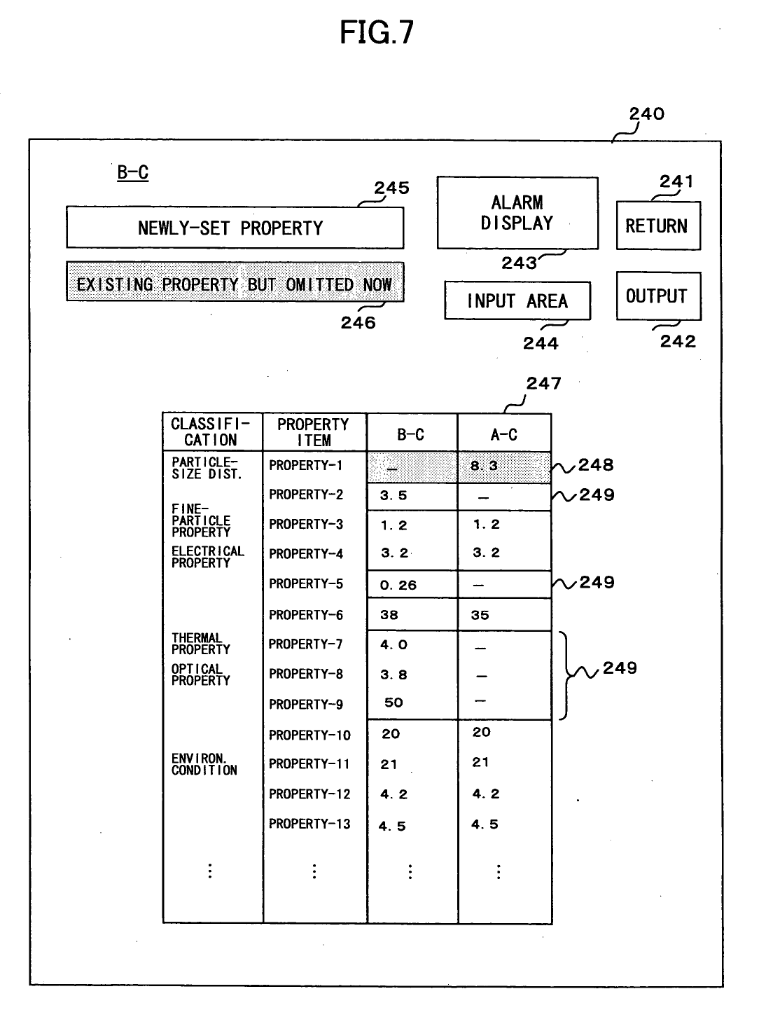

FIG. 7 is a diagram for explaining another example of the screen which contrasts the product information in the product information contrast processing.

The screen 240 of FIG. 7 indicates the product information of the selected criterion product (in this example, the product name “B-C” is chosen and displayed as the screen title) in contrast with the product information of the other products (in this example, the product name “A-C”).

The screen 240 of FIG. 7 incldues the button 241 for returning to the previously displayed screen, the output button 242 for outputting the information of the displayed screen 220 by using another processing unit, the button 243 with which the displaying of the alarm display indications of the new item, the omission, and the out-of-range property is requested, the input area 244 in which an input threshold value for the alarm display control is inputted, the display region 245 which indicates the color (the color and pattern) of the display region where the newly set property value which is not previously set is displayed, the display region 246 which indicates the color of the display region where the omitted property value which is not currently set is displayed, and the display region 247 which indicates the contrast results of the respective items of the product information between the criterion product and the other products.

In the display region 247, the classification column which indicates the classification of each product, the property column which indicates the property name related to each classification, and the product information columns which indicate the product information items of each of the product names “B-C” and “A-C” are displayed. In addition, an additional column which indicates the units of each property item may be provided to the display region 247.

In the classification column, the particle-size distribution property corresponding to the product, the fine-particle property, the-electrical property, the thermal property, the optical property, the environmental condition, etc. are displayed.

In the property column, the property values 1-13 corresponding to each of the respective properties of the product are displayed.

In addition, it is possible to make it display the property items required for contrast of other product information, without being limited to the property items shown in the display region 247. Moreover, the above-mentioned classification column and property column and their corresponding units are managed and stored in the product information DB 25 as the specifications.

In the display region 247, the contrast results of the product information items of the product name “B-C” (which is the selected criterion product) and the product information items of the other product name “A-C” are displayed in the separate, distinct colors as indicated in the display regions 248 and 249.

In the example of FIG. 7, when the specifications of the product information items of the criterion product “B-C” are not included in the specifications of the product information items of the other product “A-C”, they are displayed as in the display regions 249 with the separate, distinct color that is the same as the color shown in the display region 245.

Moreover, in the example of FIG. 7, when any specifications other than the specifications of the product information items of the criterion product “B-C” are included in the product information items of the other product “A-C”, they are displayed as in the display region 248 with the separate, distinct color that is the same as the color shown in the display region 246.

Accordingly, the product information items of the criterion product are compared with the product information items of the other products, and the property values which are different from those of the other products can be identified in the development process of the product by presenting the different-color alarm display indications according to the respective conditions.

For example, the administrator can recognize the newly set property values of the criterion prouct in contrast with the other products by viewing the display regions 249 within the region 247. The administrator can easily check the meaning of the property value differences by notifying the same to the development enginner who sets up the specifications of the criterion product. Moreover, the administrator can recognize the omitted property values of the criterion prouct but existing in the specifications of the product information items of the other products by viewing the display region 248 within the region 247. The administrator can easily check the meaning of the omitted property values of the criterion product by notifying the same to the development enginner who sets up the specifications of the criterion product.

Therefore, it is possible for the product information contrast system of the present embodiment to make the differences, obtained as the results of the recognition with the different-color alarm display indications, reflected in the specifications of the product under development, and while preventing the occurrence of the quality problem, the efficiency of development of the products can be raised.

Next, a description will be given of the table stored in the alarm information DB 26 which is used to control the alarm display indication of the new, the omission, or the out-of-range property of the product information.

FIG. 8 is a diagram for explaining a table stored in the alarm information DB 26 in the product information contrast system of the present embodiment.

In FIG. 8, the table 260 stored in the alarm information DB 26 is set up by the administrator, in advance. As shown in FIG. 8, the table 260 includes the item which indicates a predetermined range of the threshold value stored in the memory, and the item which contains the display control information to control the alarm display indications based on an input threshold value and the predetermined range of the input threshold value.

The threshold value range in the table 260 is a predetermined range of the threshold value used as the criterion for comparing the property values of the product information. The display control information in the table 260 is used to determine how the alarm display indications in the display processing are displayed according to the threshold value range when comparing the product information of Product A and the product information of Products B, C, D and E.

For example, when an input threshold value of 25% is set to the input area 224 by the administrator, the input threshold value is within the range of 25% or more and less than 50% for the threshold value item, and the display control processing corresponding to the threshold value item is performed. Namely, the alarm indication is displayed if two or more of Products B, C, D, and E have the property values which are different from the property value of Product A. Otherwise the alarm indication is not displayed.

Next, a description will be given of the screen in which the alarm indications of the new item, the omission, and the out-of-range property of the product information are displayed.

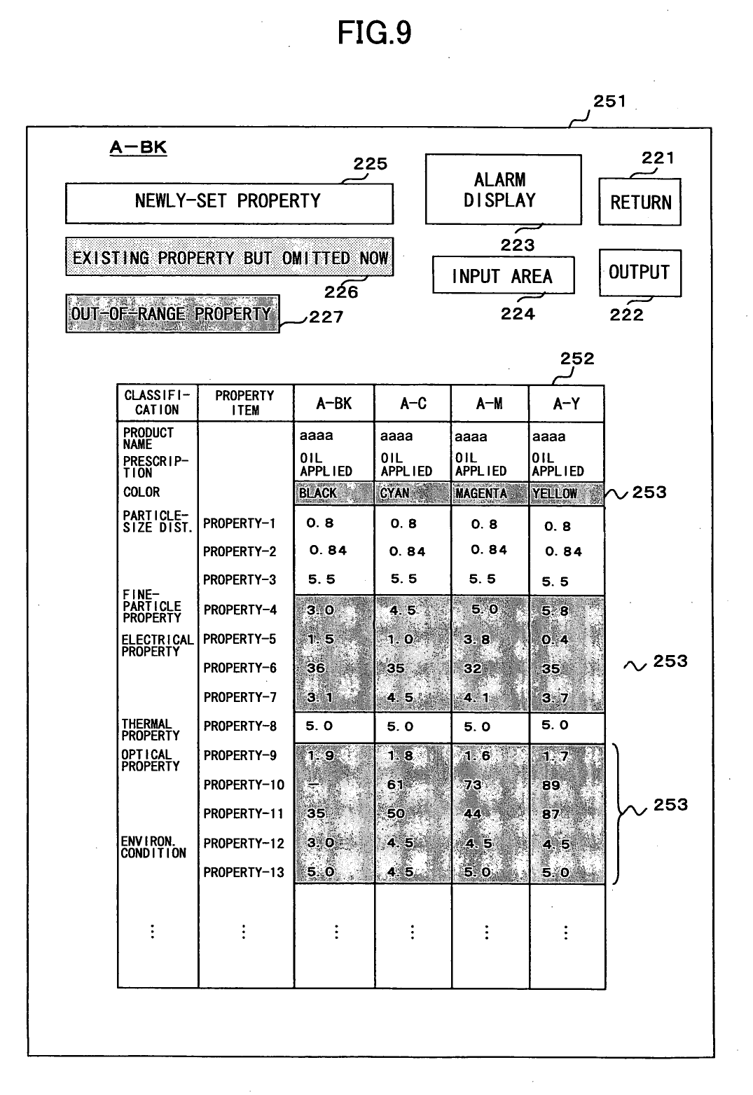

FIG. 9 is a diagram for explaining the alarm display screen for indicating the alrm information in the product information contrast processing.

The screen 251 of FIG. 9 indicates the screen when the alarm indications are displayed by comparing the items of the product information of the criterion product (the product name “A-BK”) with the items of the product information of other products than the criterion product (the product names “A-C”, “A-M” and “A-Y”).

In addition, the items in the screen 251 of FIG. 9 which are essentially the same as corresponding items in the screen 220 of FIG. 6 are designated by the same reference numerals, and a description thereof will be omitted.

The screen 251 of FIG. 9 incldues the display region 252 in which the alarm indications indicating the contrast results of each item of the product information are displayed.

For example, with the screen 251 of FIG. 9, it is assumed that the threshold value for the alarm indication displaying is inputted into the input area 224, and the button 223 for displaying the alarms of the new, the omission, and the out-of-range property is clicked. The property values of the product information of the respective products are compared based on the threshold value, and the predetermined display regions 253 within the display region 252 will be displayed in the color that is the same as the color of the display region 227 based on the comparison-results.

Thus, the items of the product information of the criterion product are compared with the items of the product information of the other products, and the properties of the criterion product (or the product under development) which are different from those of the other products can be identified in the development process of the criterion product by presenting the alarm display indications based on the threshold values.

For example, the administrator can easily recognize the alarm display indications of the new item, the omission, and the out-of-range property of the product information of the criterion product by viewing the display regions 253. Moreover, the administrator can transmit an inquiry to the related person in charge about the product specifications which are set up by the related person.

Accordingly, it is possible for the product information contrast system of the present embodiment to make the differences, obtained as the results of the recognition with the alarm displays, reflected in the specifications of the product under development, and while preventing the occurrence of the quality problem, the efficiency of development of the products can be raised.

Next, a description will be given of a screen in which the cost information, as an example of the product information, arranged according to the raw materials and the product names, is contracted, which enables the administrator to select a suitable raw material for the product under development.

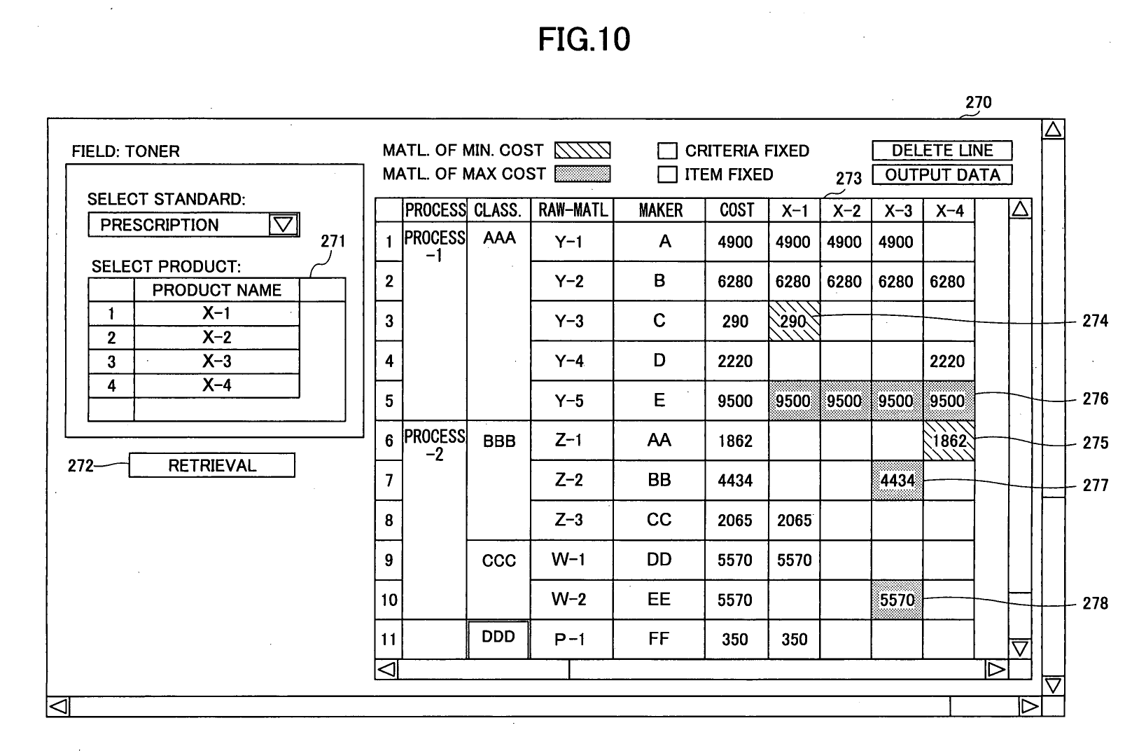

FIG. 10 is a diagram for explaining an example of the screen for contrasting the raw-material costs in the product information constrast processing.

In FIG. 10, the display region 271 which sets up the kind used as criteria and the kind to compare, and the button 272 for directing retrieval execution based on the setup are formed in the screen 270, and the result of the retrieval is displayed on the display region 273.

In the display region 273, the raw-material name classified in the direction of length according to the process and the classification is located in a line, and the maker name and cost are displayed on each.

And the cost of the kind used as criteria and the kind to compare is located in a line, and is displayed on the longitudinal direction.

In addition, it is shown that the portion of the blank does not use the raw material in the kind.

In each region range classified according to the classification matter, the material with the cheapest cost is displayed that it can recognize visually using predetermined color, pattern, etc. like the region 274 or the region 277.

Moreover, in each region range similarly classified according to the classification matter, the material with the highest cost is displayed that it can recognize visually using predetermined color, pattern, etc. like the regions 276, 277, and 278.

Thereby, using not only the reservation of quality but which raw material can know intuitively whether it is the most advantageous in cost, and it can contribute to improvements in the development of the products.

In addition, the reason of high cost or the reason of low cost can be easily recognized by mutually linking these display regions to the raw-material information, the raw-material market condition, the development purchase data, the cost table, the purchase prediction/purchase actual result information, the materials and purchase information, the base cost information, the maker information, etc.

Next, a description will be given of the master registration for providing the unified terminology for use in the product information.

It is important to provide a unifified terminology for the product information, when unifying the accuracy of each item of the product information and obtaining correct recognization of the results of the comparison between the products. An effective method for attaining this is that the inputting of the product information into the master is allowed only from the recorded terms of the master. In this method, the recorded terms of the master are displayed the pull down menu screen etc. at the time of the inputting of the new item, and the administrator is requested to choose one from among those displayed terms.

For example, there are various expressions of the term, such as “remaining styrene”, “remaining styrene monomer”, “remaining styrene content”, “residual styrene monomer”, and “residual monomer (St)”, which may be used by the persons in charge even if it is the same property item. In such a case, the variation of the terms by the respective persons in charge is avoided by using only the unified term “residual styrene” in the master.

On the contrary, there is also a case in which the same term is used in the master although it is intended to use the different property items.

For example, the “fine-particles content” is used as the property value which changes with the size of the fine particles, and it is categorized into the “fine-particles content (2 micrometers or less)” and the “fine-particles content (4 micrometers or less)”, so that such information is registered in the master.

Also, it is necessary to provide a unified terminology of the units for the master. For example, as for the unit of the magnetic property Hc, there may be various expressions, such as “{Oe}”, “KA/m”, “kA/mOe”, “O”e”, “Oe”, “kA/m”, “OekA/m”, “Oe′”, etc., which are currently used. In this case, it is necessary to provide the unified expression “Oe” for the master as the unit of magnetic property Hc. In addition, when it is difficult to provide the unified terminology due to the differences in the measuring method or the like, it is possible to dealt with the unit as another item.

Next, a description will be given of the improvement of master registration of the terms mentioned above.

Generally, when the use of a new term is set up, a request of master registration of the new term is transmitted from the development enginner terminal to the server of the administrator at that time, and the master registration of the new term is carried out by the server by receiving approval of the use of the new term from the authority concerned. Only after the master registration is completed correctly, the use of the new term will be allowed.

However, in the above case, the inputting of the product information is inhibited until the master registration of the new term is completed, which will cause the efficiency of development of the products to decline.

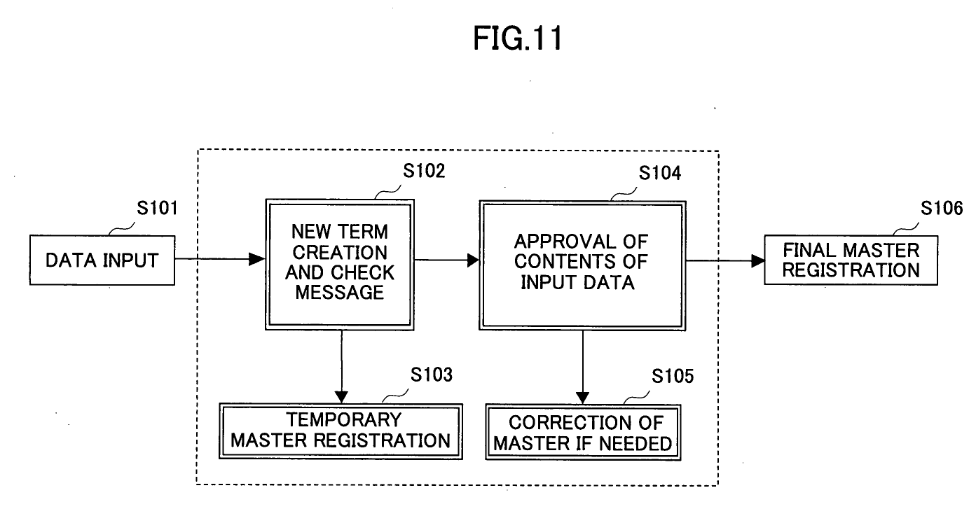

To overcome the problem, the product information contrast system of the present invention is provided with a new function of carrying out a temporary master registration. FIG. 11 is a diagram for explaining the flow of a temporary master registration processing.

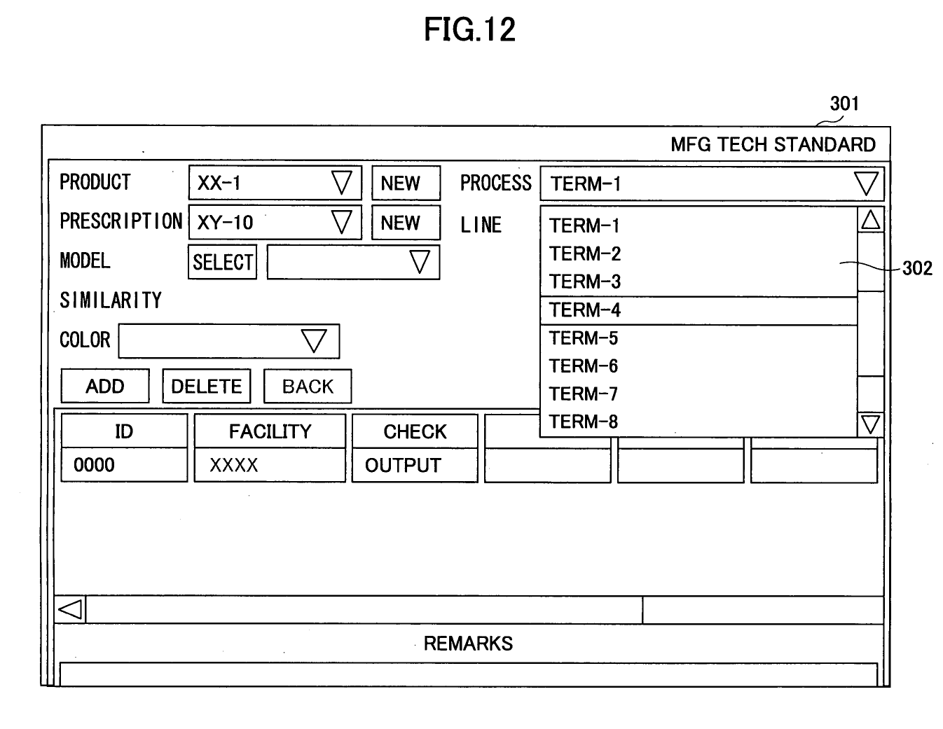

First, the data input of product information is performed on the development engineer terminal (step S101). FIG. 12 shows a screen for inputting data.

In such circumstances, each term will be inputted from the data input screen 301 by choosing the item from the pull down menu 302 displayed therein and clicking with the mouse as shown in FIG. 12. It is possible to prevent the terms not registered in the master from being used.

Subsequently, when the setting of new terminology is needed in the data input step S101 of FIG. 11, the function of creation of new terminology is chosen. The setting of new term is performed and a check message is confirmed, so that a temporary master registration of the new term is performed (steps S102 and S103).

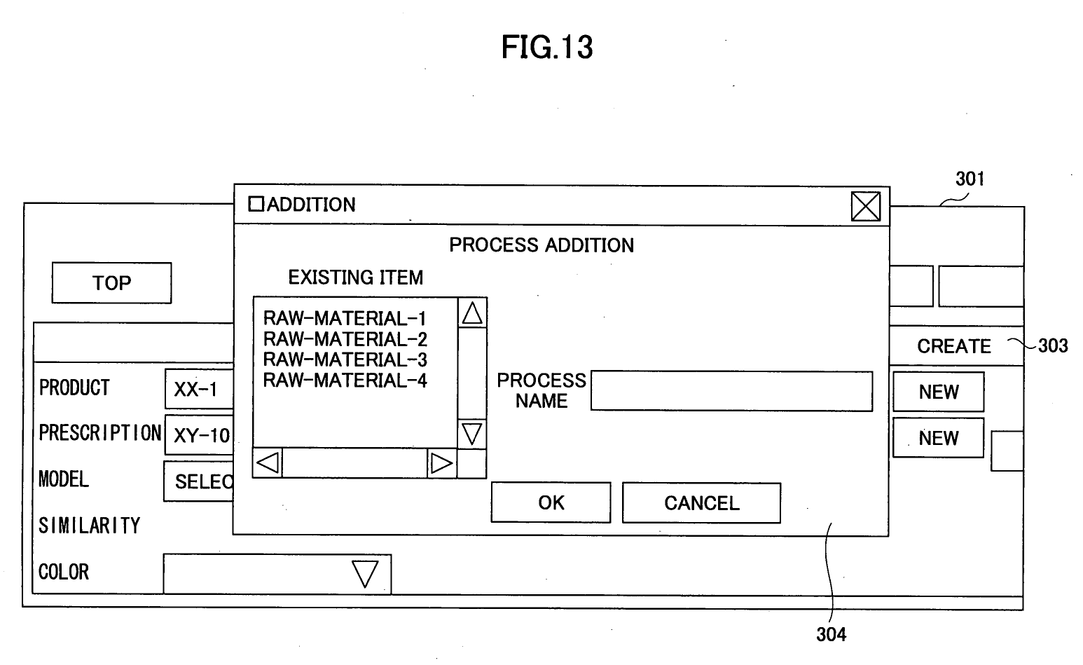

FIG. 13 shows an example of a screen for inputting a new term. As shown in FIG. 13, the “addition” screen 304 will be displayed by clicking the “create new” button 303 of the screen 301 with the mouse. While checking the existing items, the new term can be inputted.

Although the term with which the temporary master registration is performed is not finally fixed in the master, it can be used for the data input of the product information similar to the usual terms with which the master registration is performed.

Next, in the flow of FIG. 11, approval of the contents of the input data is performed by the administrator (step S104). If the necessity arises, the correction of the input data is performed (step S105) and a final master registration is performed (step S106).

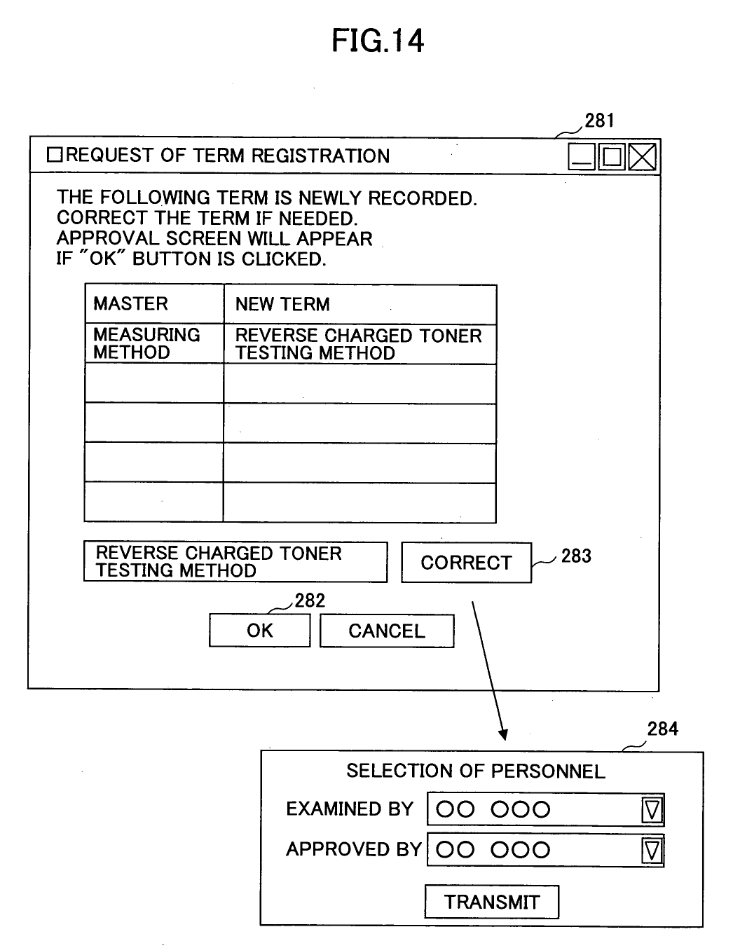

FIG. 14 shows an example of a screen of term recognition request. As shown in FIG. 14, the contents of the new term are confirmed from the screen 281 which indicates the new term of temporary registration, and the “OK” button 282 is clicked if approved without correction. On the other hand, if the correction of the new term is needed, the corrected term is set up and then the “correct” button 283 is clicked.

Thereby, the display indication is transferred to the “selection of personnel” screen 284 in the approval workflow, and the final master registration is carried out through approval of the selected persons of a predetermined authority.

Next, a supplementary description will be given of the above-described embodiments.

In an alternative embedment, the visibility and operability of the product information contrast sustem can be raised by displaying the product information which is formatted into a tree structure, when a selection of each item of the product information is requested, and allowing the user to make a choice from among the items of the product information in the tree-structure format.

In the example of FIG. 5A, the items of the product information can be chosen with the buttons 204 to 208, such as the per product indication, the per prescription indication, the per model indication, the per category indication, and the per standard indication. In the alternative embodiment mentioned above, the product information which is formatted into a tree structure is displayed, instead of or together with such display indications, allowing the administrator (or the user) to make a choice from among the items of the product information in the tree-structure format.

Furthermore, in the above-mentioned preferred embodiments, the corresponding display region is displayed in a separate color different from the color of the background, which is provided as an example of the visually recognizable display indication. However, the present invention is not limited to these embodiments. In alternative embodiments, various methods of providing a visually recognizable display indication may be applied by using a different character color or font, changing the size, or adding a pop-up display indication.

In addition, in order to provide a more clearly reconizable display indication of the difference in the displayed numeric values in arrays of numeric values, the method of displaying a graphic screen in response to clicking of the mouse, and the method of displaying a tree-structure screen which indicates the result of expansion of a brief display indication can also be applied.

Furthermore, in the above-mentioned preferred embodiments, the visually recognizable display indication is used to provide the alarm displays of the new item, the omission, the out-of-range setting of the product information. Alternatively, the above embodiments may be modified so that the function of e-mail or facsimile communications is interlocked with the alarm displays, and the related sections of the maker and part suppliers are automatically notified of the alarm displays.

Moreover, the efficiency of development of the products can be further raised by providing not only the alarm display indications but also the display indication of a suitable countermeasure to be taken against the problem.

Furthermore, in alternative embodments, an additional display screen indicating the quality problem, the cost information, the measuring method or the quality information may be provided in response to the clicking of the mouse on the corresponding property item from the screen in which the items of the product information are arrayed side by side according to the kind of the products as shown in FIG. 6, FIG. 7 and FIG. 9. According to such alternative embodiment, it is possible to quickly provide the user with the useful information, and the efficiency of development of the products can be raised further.

For example, the user can easy set up the countermeasure for improvement in the quality of the product of concern by viewing a display indication of the quality problem which has been already discovered. The user can easily select a low-cost material by viewing a display indication of the cost information. The mistakes by the difference in the measuring method can be reduced by viewing a display indication of the measuring method, and the cause of the quality problem can be quickly discovered by viewing a display indication of the quality information.

Furthermore, in alternative embodments, an additional display screen collectively indicating the indication specifications of other products may be provided following the screen in which the items of the product specifications are arrayed in the vertical direction as shown in FIG. 6, FIG. 7 and FIG. 9. According to such alternative embodiment, it is possible to realize early detection of the problem at the upstream portion of the manudacturing processes of the product of concern. In this case, by sorting and displaying based on the property items etc., it adjoins in the direction of length, and the contents of the inspection specifications related to the same property items can be arrayed and displayed.

Furthermore, the product information is mainly expressed as characters in the above-mentioned preferred embodiments, but the present invention is not restricted to the above-described embodiments. In a certain alternative embodiment, by providing the function of a display indication of rich text data, it is possible to display the chemical formula, the photograph, the sensitivity graph, the toner particle-size distribution, the thermal-analysis result, the flow tester chart, etc. and it is possible to provide the user with an intuitively recognizable display indication.

Moreover, by providing the function of a display indication of rich text data in the screen linked and displayed in response to the clicking of the mouse from the screen of the product information, it is possible to provide the user with an intuitively recognizable display indication.

Furthermore, in an alternative embodiment, by the function to search automatically the product information, such as the product information of the kind corresponding to the specified specifications, in the display screen of the product information contrast system. Thereby, it is possible for the user to quickly display and acquire a desired item of the product information, and the efficiency of development of the products can be raised further.

Furthermore, in an alternative embodiment, by providing an automatic translation function, it is also possible to treat in the same manner the product information of overseas makers indicated in a foreign language.

Furthermore, it can check from the site of the product development on real time, and the efficiency of development of the products can be further raised by enabling a mobile PC to access to the product information contrast system.

The present invention is not limited to the above-described embodiments, and variations and modifications may be made without departing from the scope of the present invention.

Further, the present application is based on Japanese priority application No. 2003-058916, filed on Mar. 5, 2003, and Japanese priority application No. 2004-027900, filed on Feb. 4, 2004, the entire contents of which are hereby incorporated by reference.

What is claimed is

1. A product information contrast system which contrasts a plurality of items of product information that contain specifications indicating properties of products, the product information contrast system comprising:
a product information management unit managing the plurality of items of product information of the products including a criterion product;
a judgment unit determining whether specifications in the product information items of the criterion product are different from specifications in the product information items of at least one of the products managed by the product information management unit; and
a display control unit generating a visually recognizable display indication of differences in the specifications of the product information items based on results of the determination of the judgment unit.

2. The product information contrast system according to claim 1 further comprising a selection unit selecting arbitrary one of the product information items of the products, managed by the product information management unit, as being one of the product information items of the criterion product.

3. The product information contrast system according to claim 1 wherein the display control unit is configured to generate a visually recognizable alarm display indication when the results of the determination of the judgment unit indicate that the specifications of the product information items of the criterion product are not included in the specifications of the product information items of said at least one of the products.

4. The product information contrast system according to claim 1 wherein the display control unit is configured to generate a visually recognizable alarm display indication when the results of the determination of the judgment unit indicate that any specifications other than the specifications of the product information items of the criterion product are included in the product information items of said at least one of the products.

5. The product information contrast system according to claim 1 further comprising a threshold setting unit setting a threshold value for the product information items of the criterion product, which is provided to determine whether the specifications of the product information items of the criterion products are related to a newly set property, an omitted property, or an out-of-range property when compared with the specifications of the product information items of the products,
the judgment unit configured to determine whether the specifications of the criteria product are different from the specifications of the products, based on the threshold value of the setting unit,
the display control unit configured to generate a visually recognizable alarm display indication of the newly set property, the omitted property, or the out-of-range property in the specifications of the product information items related to the criterion product, based on the results of the determination of the judgment unit.

6. The product information contrast system according to claim 5 further comprising a display control information management unit managing display control information to control the alarm display indication based on an input threshold value and a predetermined range of the input threshold value,
the display control unit configured to generate the visually recognizable alarm display indication of the newly set property, the omitted property, or the out-of-range property, based on both the results of the determination of the judgment unit and the display control information managed by the display control information management unit.

7. A computer program product for controlling a computer having a product information management unit managing a plurality of items of product information containing specifications indicating properties of products including a criterion product, to perform:
determining whether specifications in the product information items of the criterion product are different from specifications in the product information items of at least one of the products managed by the product information management unit; and
generating a visually recognizable display indication of differences in the specifications of the product information items based on results of the determination of the judgment unit.
